(19) United States
(12) Patent Application Publication
(10) Pub. No.: US 2014/0076606 A1
(43) Pub. Date: Mar. 20, 2014

(54) Subterranean Cable

(71) Applicant: BPP Cables Ltd., London (GB)

(72) Inventor: Darren Lindsay Patel, Essex (GB)

(21) Appl. No.: 14/030,349

(22) Filed: Sep. 18, 2013

(30) Foreign Application Priority Data
Sep. 18, 2012 (GB) 1216685.6
Dec. 20, 2012 (GB) 1223227.8

(51) Int. Cl. H01B 7/28; H01B 13/016; H01B 7/29

(52) U.S. Cl. CPC H01B 7/28; H01B 7/29; H01B 13/016
USPC 174/102 A; 174/102 R; 29/828

(57) ABSTRACT

The present invention relates to a cable comprising three conductors and three insulator layers, wherein the conductors and the insulators extend helically along a longitudinal axis of the cable, wherein the insulator layers are axially external to the conductors, and wherein the insulator layers comprise a fluoropolymer, as well as a method of manufacturing said cable, and a method for transmitting electricity using the cable.

### CROSS-REFERENCE TO RELATED APPLICATIONS

This application claims priority to United Kingdom Patent Application Nos. GB1216685.6 filed on Sep. 18, 2012 and GB1223227.8 filed on Dec. 20, 2012, which applications are incorporated by reference herein in their entirety.

### FIELD OF INVENTION

The present invention relates to a cable for conducting electricity and carrying tension, and is particularly useful for subterranean applications. The invention also relates to an insulation layer to electrically insulate the conductor component of such cables.

### BACKGROUND

Devices are routinely placed in wellbores during the course of oil exploration or production. Such devices are often powered by electricity, which is transmitted by power cables from the surface. Devices include monitoring devices (to provide information regarding the subterranean formations surrounding the wellbore) and pumps (to aid in pumping oil to the surface).

The downhole environment and the power requirements of the devices present a number of challenges when providing such cables. For instance, the downhole environment may be corrosive (for instance, the environment may exhibit extremes of pH's, or may be oxidative or reductive, for instance, if hydrogen sulphide is present), and thus cables need to be resistant to such challenges. Downhole temperatures can vary with depth; typically temperatures increase with increasing depth, meaning the components of the cable must function properly in a wide range of temperatures. If the power cable is also used to suspend, or lower and lift devices into and out of the wellbore, the power cable must be strong enough to support the devices. Not only must such cables be strong enough to support the devices, an important consideration is that they must be strong enough to support their own weight: where the depth of wellbore is several hundreds, if not thousands of meters long, the self-weight of the cable itself may be substantial. The cable must also be mechanically robust and resilient so that an operator can use it in the field repeatedly without concern that it will fail. Most importantly, the cable must be capable of providing sufficient electrical power to any device downhole. Finally, wellbore environments are typically restricted in terms of space, which in turn places restrictions on the maximum allowable cable diameter. A typical wellbore may have an inner diameter as small as around 5 inches, and the maximum diameters of cables are typically restricted to a fraction of the wellbore diameter. These requirements, taken together, present challenges when providing cables suitable for use downhole.

### SUMMARY OF THE INVENTION

In a first aspect, the present invention provides a cable comprising three or more cores, each core comprising a conductor and an insulator layer disposed axially external to the conductor, wherein each core extends along a longitudinal axis of the cable, wherein the insulator layer comprises a first fluoropolymer, and a first plurality of wires disposed axially external to the three or more cores and extending along a longitudinal axis of the cable.

In a second aspect, the present invention provides a cable comprising of electrical conductors and insulator layers, wherein the conductors and the insulator layers extend along a longitudinal axis of the cable, preferably in a helical configuration, wherein the insulator layers are axially external to the conductors, and wherein the insulator layers comprise a fluoropolymer.

In a third aspect the present invention provides a use of a fluoropolymer, as an insulator in an armoured cable.

In a fourth aspect the present invention provides a method of manufacturing a cable comprising three or more cores, each core comprising a conductor and an insulator layer disposed axially external to the conductor, wherein each core extends along a longitudinal axis of the cable, wherein the insulator layer comprises a first fluoropolymer, and a first plurality of wires disposed axially external to the three or more cores and extending along the longitudinal axis of the cable, comprising disposing the insulator layer around the conductor and along a longitudinal axis thereof to form each of the three or more cores, and disposing the first plurality of wires around the three or more cores and along the longitudinal axis of the cable.

In a fifth aspect the present invention provides a method of transmitting electricity, comprising connecting a first installation or device with a second installation or device with a cable according to the present invention, and transmitting electricity from the first installation or device to the second installation or device through the cable, wherein the first installation or device is in a wellbore.

In a sixth aspect the present invention provides a method of suspending a first device or installation in a wellbore, comprising providing the cable of the invention, securing a first end of the cable to the first device or installation, securing a second end of the cable to a second device or installation, and suspending the first device or installation in the wellbore.

Further features are defined in the dependent claims.

### BRIEF DESCRIPTION OF THE DRAWING

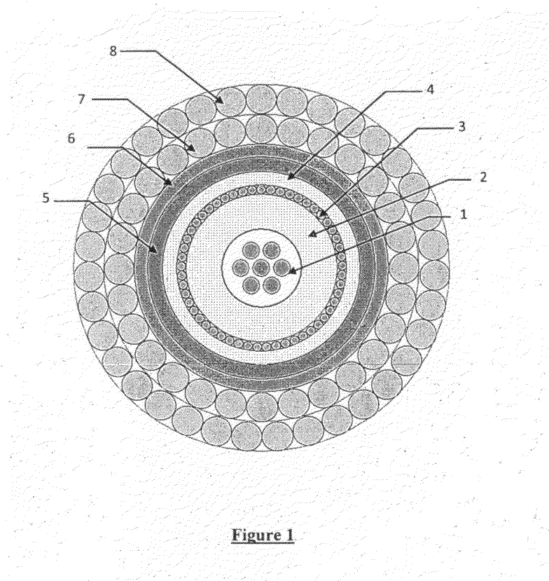

The accompanying FIG. 1 helps illustrate the example and the present invention, but is not to be construed as limiting the invention. FIG. 1 shows a cross section of an embodiment of the cable of the present invention, and is not to scale. The conductors 1 and insulator layers 2 form the core of the cable. The cable may be formed of a plurality of wires (7 are schematically shown, although more may be used). The conductors 1 are surrounded by insulator layers 2. Each insulation layer is surrounded by a braiding layer 3. The braiding layer is surrounded by fillers in layer 4. The fillers are surrounded by a copper tape 5. The copper tape is surrounded by a bedding/barrier layer 6. Armour wires are situated around the outside of the cable—a first plurality 7 is disposed in a layer, which is surrounded by a second plurality of wires 8.

### DETAILED DESCRIPTION

The present invention relates to a cable for conducting electricity, in particular, for cables used in subterranean applications. The invention also relates to insulation layers to insulate the conductor components of such cables. The cables of the present invention are useful for providing AC (alternative current) electricity to downhole devices, as well as DC (direct current) electricity.

The cable may be used to power any downhole device that uses electricity, and is particularly useful for powering ESPs (electrical submersible pumps). The present invention is particularly useful when configured as a high strength tensile cable for supporting and powering ESPs. The cable of the present invention is capable of operating at around 5 kV to 6 kV, with a current carrying capacity of 65 A to 150 A. The cable can also be subjected to relatively high temperatures. For instance, the cable may be used in downhole temperatures of up to 80° C., up to 90° C., up to 100° C., up to 120° C., up to 130° C., up to 140° C., or up to 150° C. Further, the cable may be used in corrosive environments, for instance, in low or high pH's, or in oxidative or reductive environments. For instance, the cable is able to tolerate exposure to hydrogen sulphide of around 4%-6% (mol). The cable may also be subjected to working loads of at least 8,000 lbs (35.6 kN). In a particularly preferred embodiment, present invention provides an AC cable for powering an ESP.

The cable of the present invention comprises three conductors and three insulator layers, wherein the conductors and the insulators extend along a longitudinal axis of the cable, preferably in a helical configuration, wherein each insulator layer is axially external to each conductor to thereby form each core, and wherein the insulator layers each comprise a fluoropolymer. The helices of the cores preferably intertwine around each other. This configuration is particularly advantageous in that the cable is provided with flexibility and resistance against fatigue induced from bending forces applied to the cable. The cable further comprises a first plurality of wires disposed axially external to the three cores and extending along a longitudinal axis of the cable.

International standard IEC 60287 (set out by the International Electrotechnical Commission) provides ampacity calculations for the sizes of the central and return conductors for medium-voltage and high voltage power cables of various construction types. The conductors of the present invention are sized to allow for sustained and safe level of current which does not lead to overheating of the cable, such that the maximum allowable operating temperature is not exceeded. Overheating can lead to a number of problems, such as premature degradation and break down of the insulation layers. Other factors which determine conductor sizing include the operating environment, expected number of flex cycles during operation, mechanical capacity, the cable type and its service conditions.

When the conductors are energized, heat is generated within the cable due to the electrical losses, the dielectric losses in the insulation and the losses in the metallic elements of the cable. The size and ampacity of the cable is dependent on the way the heat is transmitted to the cable surface and ultimately dissipated to the surrounding environment. The rate of heat dissipation is dependent on the various thermal resistances of the cable materials and on the external medium and ambient temperature. If the cable is able to dissipate more heat, the conductors can be smaller for a given current carrying capacity.

The normal maximum continuous rating of the cable is dependent on a number of factors. The most important of these is the maximum permissible conductor temperature rise (above ambient temperature). The maximum current rating is the loading (in amperes) which, when applied continuously until steady state conditions are reached, will produce the maximum allowable conductor temperature. Steady state is reached when the rate of heat generation in the cable is equal to the rate of heat dissipation from the cable's surface. This state is the primary condition considered when calculating current rating. The resistance of the conductors should be as low as possible to minimize power losses from the conductors.

In an embodiment, the conductors comprise tinned copper or copper alloy. Copper has a number of properties that make it a suitable material for a conductor, such as excellent conductivity and mechanical strength, and thus is the most preferred conductor material. Different grades of copper may be used if desired (e.g. UNS C11000 or C10300—note “UNS” stand for “unified numbering system”). Copper alloys such as copper beryllium alloys (e.g. UNS C17000), copper brass alloys (e.g. UNS C26000), copper nickel alloys (e.g. UNS C71500 or C71640), copper aluminium brasses (e.g. UNS C68800) may also be used for the conductors. Such alloys may provide slightly improved mechanical characteristics (such as higher tensile and fatigue strengths), but may do so at the expense of slightly lower thermal and electrical conductivities, or increased cost. The skilled person will appreciate whether copper or a copper alloy should be used in the cable of the present invention.

The conductor may be formed of a single strand (also known as a solid core), or a plurality of stranded wires. The plurality of stranded wires is preferred, due to its improved flexibility and improved resistance to fatigue compared to solid core configurations. The plurality of wires in DC cable may also be braided, since braids further improve the resistance of the conductor to fatigue. In particular, the braid configuration provides good electrical and mechanical performance, at the same time exhibiting good resistance to forces generated from repeated pulling and relaxing of the cable that can occur during operation.

The insulation layers of the present invention comprise a fluoropolymer. The insulation layer serves to insulate and electrically isolate the conductor from other components of the cable. The insulation thickness should be sufficient to sustain the electrical stresses developed during cable operation.

Electrical field distribution depends on the specific conductivity of the insulation, which itself is highly dependent on the temperature and electric field. The highest electrical stress develops in the insulation region closest to the conductor, as the electric field drives the stress distribution while the cable carries no load. As the cable is subjected to full load, a temperature gradient develops, and this affects the electrical stress much more than the electrical field previously did. As a result of a temperature rise near the conductor, the electrical stress exhibits a tendency for an increase at the outer radius of the insulation and a decrease in the insulation region closer to the conductor.

The fluoropolymers of the present invention will now be described. Fluoropolymers are polymers based on fluorocarbons, which comprise strong carbon-fluorine bonds. Such polymers exhibit high resistance to solvents, acids and bases, as well as a good resistance to high temperatures. Some fluoropolymers are known for their non-stick and friction-reducing properties. The best known example of a fluoropolymer is polytetrafluoroethylene, commercially available as Teflon™, which is commonly used as a non-stick coating for cookware. As used herein, the term “fluoropolymer” means any molecule comprising at least one repeating structural unit, where the at least one structural unit comprises at least one carbon-fluorine bond. Each structural unit is preferably covalently bonded to another structural unit. A typical fluoropolymer comprises a backbone of repeating —(CR₁R₂—CR₃CR₄)— structural units, where at least one of R₁ to R₄ is a fluorine atom. Provided at least one of R₁ to R₄ is a fluorine atom, possible moieties for the other R₁ to R₄ (i.e. the ones that are not fluorine) may be individually selected from —H, —CH₃, —CF₃, —Cl, —CCl₃, —OCH₃, —OCF₃, —OCF₂CF₃, —OCF₂CF₂CF₃, and —OCF₂CF₂ CF₂CF₃. Each of the repeating structural units can be identical, Alternatively, there can be two, three or more distinct structural units; where there are two or more structural units, the resulting polymer is typically called a copolymer.

The molecular sizes of the fluoropolymers of the present invention may vary, but are sufficiently large such that they are solid at the temperatures at which the cables of the present invention operate. The minimum melting temperatures of any fluoropolymer for use with the invention may be 225° C., 230° C., 235° C., 240° C., 245° C., 250° C., 255° C., or higher.

In an embodiment, the fluoropolymer is a polymer consisting of one monomer. In another embodiment the fluoropolymer is a copolymer comprising two different monomers. In another embodiment, the fluoropolymers may comprise three, four or more different monomers.

The insulator layer of the cable comprises a first fluoropolymer. The first fluoropolymer may comprise, or consist of, a first monomer. The first monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The first fluoropolymer may further comprise a second monomer. In another embodiment, the first fluoropolymer may consist of a first and a second fluoropolymer. The second monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

In a preferred embodiment, the first fluoropolymer consists of two alternating monomers of ethylene and 1,1,2,2-tetrafluoroethylene, given by the structure (—CH₂—CH₂—CF₂—CF₂—)ₙ. The fluoropolymer is also known as ETFE, or poly(ethylene-co-tetrafluoroethylene). This fluoropolymer is commercially available under the brand names Tefzel™, Fluon™, Neoflon™ and Texlon™. ETFE exhibits a number of desirable properties, including a high melting temperature and high chemical resistance. In another preferred embodiment, the first fluoropolymer consists of one monomer of 1,1,2,2-tetrafluoroethylene. The structure of this polymer is (—CF₂—CF₂—)ₙ, and is known as poly(1,1,2,2-tetrafluoroethylene), or PTFE.

The use of fluoropolymers in the insulation layers is unusual. This is because such materials are not typically used as insulators, since there are other insulator materials which are normally used. Usually synthetic rubber based materials such as EPDM (ethylene propylene diene monomer) are used, since they provide acceptable insulation capabilities in most circumstances, but at a reduced cost compared to fluoropolymers. However the surprising discovery has been made that fluoropolymers (in particular, PTFE and ETFE) provide better electrical insulation at a broader temperature range (in particular, at elevated temperatures). Further, fluoropolymers (especially ETFE and PTFE) exhibit an improved decomposition temperature, durability and chemical resistance compared to known insulators, which in turn allows for a higher conductor temperature, which in turn allows for a greater steady state current. The higher resistance to thermal and chemical degradation also contributes to a reduced degradation of the insulating layer, thereby leading to an improved longevity of the cable itself. This higher resistance is also thought to allow the cable of the present invention, when used as an ESP cable, to be deployed downhole for relatively long periods compared to existing ESP cables.

Since the electrical insulating capabilities of the insulating layers are improved at higher temperatures, the present invention in turn allows for a thinner insulation layer than previously possible. Further, fluoropolymer insulation provides higher hoop (circumferential) strength to the cable core than rubber insulation. This allows for thinner insulation layers and in some cases removal of braided reinforcement which in turn allows for an improved capability of the cable to dissipate heat from the conductors, as well as allowing for thicker conductors for a given diameter of cable (i.e. since the maximum diameter of the cable is limited due to the constraints imposed by the limited space of the wellbore, if a lower proportion of the diameter is taken up by the insulators, then other components such as the conductors can occupy a greater proportion of the diameter). The combination of thinner insulation layers and thicker conductors together provides an improvement in the ampacity of the cable.

In addition, fluoropolymers exhibit other desirable characteristics making them suited for use as insulation for downhole cables. This includes low dielectric loss; good resistance to stress cracking; good resistance to chemicals; excellent mechanical properties, such as high tensile strength, ‘cut-through’ resistance, and low creep. Fluoropolymers exhibit an ideal level of stiffness that means it is not too stiff, such that the cable has enough flexibility for use, but not too flexible and soft, such that the insulation material does not extrude through the armour wires when the cable is under tension. Furthermore, fluoropolymers retain these properties at the higher temperatures, which means these advantages are seen across the range of temperatures seen downhole. ETFE is a particularly advantageous fluoropolymer for use with the invention in this regard.

The fluoropolymers used in any layer of any embodiment of the invention may be foamed or non-foamed. Foaming the fluoropolymers may reduce costs by reducing the amount of material used. However, the fluoropolymers used with the invention are preferably non-foamed, since the advantages listed above may be reduced to some extent when the fluoropolymer is foamed.

Note the cables of the present invention may need to be deployed in wellbores with diameter as low as 4.9 inches (12.5 cm), or even smaller, meaning the cables need to be as small as possible.

The cable may further comprise braiding layers, which are external to the insulator layers. The braiding layers increase the hoop strength of the insulation. They are particularly beneficial during rapid gas decompression of entrapped gases. The typical material used in the braiding layers is aramid fibre.

The cable may further comprise filler material, which may be used to fill the interstices between the at least three cores of the cable. The filler material may aid is supporting the structure of the cable, and to maintain its circularity. The filler material may comprise a second fluoropolymer, which advantageously shows small expansion from the ingress of oil and the thermal response.

The second fluoropolymer may comprise, or consist of, a third monomer. The third monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The second fluoropolymer may further comprise a fourth monomer. In another embodiment, the second fluoropolymer may consist of a third and a fourth fluoropolymer. The fourth monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. In a preferred embodiment, the second fluoropolymer consists of two alternating monomers of ethylene and 1,1,2,2-tetrafluoroethylene or most preferably, the second fluoropolymer consists of one monomer of 1,1,2,2-tetrafluoroethylene, i.e. PTFE.

The cable may further comprise a copper tape, which may be disposed external to the core bundle, including the conductors, the insulator layers, the braiding layers and the filler. The copper tape is used to hold the components of the cable in place. The copper tape may also advantageously serve as a further barrier to fluids encountered during use, such as water, oil, and any gases found in the environment, thereby protecting the cores disposed internally to the copper tape.

The cable may further comprise a bedding/barrier layer, which layer may comprise a third fluoropolymer, wherein the bedding/barrier layer extends along the longitudinal axis of the cable and is external to the copper layer. The bedding/barrier layer provides a number of roles, including providing further insulation of the internal components of the cable from the external environment or any current in the armour, but also provides an impermeable layer to prevent ingress of any gas and liquid into the interior of the cable, and to protect the internal conductors and insulator layers from corrosive substances found in the wellbore, such as hydrogen sulphide. The bedding/barrier layer also provides mechanical protection of the internal components from the environment and the armour wires. In particular, when the cable comprises an external layer of armour wires (see below), such armour wires can deform under load, and return to their original geometry during unloading. This deformation of the armour wires subjects the internal components of the cable to considerable mechanical stress.

The bedding/barrier layer of the cable may comprise a third fluoropolymer. The third fluoropolymer may comprise, or consist of, a fifth monomer. The fifth monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The third fluoropolymer may further comprise a sixth monomer. In another embodiment, the third fluoropolymer may consist of a fifth and a sixth monomer. The sixth monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. In a preferred embodiment, the third fluoropolymer consists of one monomer of 1,1,2,2-tetrafluoroethylene, i.e. PTFE, or most preferably, the third fluoropolymer consists of two alternating monomers of ethylene and 1,1,2,2-tetrafluoroethylene, i.e. ETFE.

As described previously, the first, second and third fluoropolymers may consist of, or comprise, one or two monomers. However the first, second and third fluoropolymers may alternatively further comprise three, four of more monomers. These further monomers may be selected from the list of monomers described above.

As noted above, in a preferred embodiment, the insulation layers, the filler and the bedding/barrier layer comprise of or consist of PTFE, ETFE and PTFE, respectively. However, it will be appreciated that other combinations of fluoropolymers are envisaged. For instance, all fluoropolymers may be the same, e.g. all consisting of, or comprising, ETFE or PTFE. Alternatively, all fluoropolymers may be different.

The insulator layers and the bedding/barrier layer may be formed by extrusion, thereby providing a contiguous and seam-free layer. Alternatively, they made by formed by wrapping or winding tape around the cable. If tapes of material are used, then it is important that tapes are wrapped/wound in a manner to create a continuous layer. Since extrusion is more likely to provide contiguous/seam-free layers, extrusion is referred.

The cable comprises a first plurality of wires, wherein the first plurality of wires extends along the longitudinal axis of the cable and is axially external to the three or more cores. If the cable further comprises a copper tape and/or a bedding/barrier layer, then the first plurality of wires may be disposed axially externally to these features. These armour wires fulfil a number of roles. They provide tensile strength to the cable, such that it can both support its own weight, and that of any devices suspended using the cable during operation in a wellbore. This means that the cable of present invention can support other commonly used downhole devices, such as pumps, sensors and motors, in addition to its own self-weight. This is particularly useful when the cable of the present invention is used for powering an ESP, since not only can it support its own weight, it can support other equipment typically used during the operation of an ESP, such as the pump, motor and inverter. This is in contrast with presently available ESP cables, which lack tensile capacity and thus do not bear any weight themselves. This means presently available ESP cables are typically strapped to other cables/wires which are run into the hole in parallel with the ESP cables to specifically provide the load-bearing function. The armour wires also provide the cable with integrity, in particular, by preventing the cable from flattening (and thus squashing the internal components), as well as preventing twisting, stretching and over-flexion of the cable. The cable may further comprise a second plurality of wires, wherein the second plurality of wires also extends along the longitudinal axis of the cable and is axially external to the first plurality of wires. Preferably, the wires of the first plurality of wires are helically wound in a first direction, and the wires of the second plurality of wires are helically wound in a direction opposition to the first. Providing two sets of wires provides a greater level of protection and load-carrying capacity compared to having just one set of wires. Winding of the two sets of wires in this manner provides the armour wires with further resistance against torsional, flexural and stretching forces.

Armour wires can be made of a resilient metal such as steel or steel alloy. However, given the armour may be subjected to harsh and corrosive environments, other materials with improved resistance to corrosion may be used instead, such as galvanised steel, stainless steel, or high strength stainless steel. For instance, the armour wires may be made of GIPS (galvanised improved plow steel) wires. However, GIPS is prone to cracking in H₂S-rich environments, which may lead to wire failure. Stainless steel, for instance, may be more resistant to hydrogen sulphide than galvanised steel.

In a particularly preferred embodiment, the armour wires comprise of, or consist of, a nickel-based alloy, which may provide the wires with a high resistance to cracking from exposure to hydrogen sulphide. Suitable nickel-based alloys comprise of, or consist of, nickel and chromium and optionally up to 20% (w/w) additives or impurities. The additives or impurities include, but are not limited to, iron, molybdenum, niobium, cobalt, manganese, copper, aluminium, titanium, silicon, carbon, sulphur, phosphorus or boron, or any combination thereof. The nickel-based alloy may comprise of, or consist of, from 40 to 74% (w/w) nickel, 14 to 25% (w/w) chromium, and optionally up to 20% (w/w) additives or impurities.

The nickel based alloy may comprise, or consist of, 72% (w/w) nickel, 14-17% (w/w) chromium, 6-10% (w/w) iron, 1% (w/w) manganese, 0.5% (w/w) copper, with remainder impurities or additives (this alloy is available commercially under the name Inconel 600™).

The nickel based alloy may comprise, or consists of, 44.2%-56% (w/w) nickel, 20-24% (w/w) chromium, 3% (w/w) iron, 8-10% (w/w) molybdenum, 10-15% (w/w) cobalt, 0.5% (w/w) manganese, 0.5% (w/w) copper, 0.8-1.5% (w/w) aluminium, 0.6% (w/w) titanium with remainder impurities or additives (this alloy is available commercially under the name Inconel 617™).

The nickel based alloy may comprise, or consists of 58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives (this alloy is available commercially under the name Inconel 625™). This is the most preferred nickel-based alloy for use with the invention.

The nickel based alloy may comprise, or consists of 50-55% (w/w) nickel, 17-21% (w/w) chromium, 2.8-3.3% (w/w) molybdenum, 4.75-5.5% (w/w) niobium, 1% cobalt, 0.35% (w/w) manganese, 0.2-0.8% (w/w) aluminium, 0.65-1.15% (w/w) titanium, 0.3% (w/w) copper with remainder impurities or additives (this alloy is available commercially under the name Inconel 718™).

The nickel based alloy may comprise, or consists of 70% (w/w) nickel, 14-17% (w/w) chromium, 5-9% (w/w) iron, 0.7-1.2% (w/w) niobium, 1% (w/w) cobalt, 1% (w/w) manganese, 0.5% (w/w) copper, 0.4-1% (w/w) aluminium, 2.25-2.75% (w/w) titanium with remainder impurities or additives (this alloy is available commercially under the name Inconel X-750™).

The diameter of the cable, and the thickness of the various layers, may be varied. In an embodiment, each of the three conductors may have a cross-sectional area in the range of 25 to 45 mm², preferably 28 to 38 mm², more preferably 31 to 35 mm², most preferably 33.6 mm². Each insulator layer of each core may have a thickness in the range of 1 to 4 mm, preferably 1.4 to 3 mm, more preferably 1.8 to 2.5 mm, most preferably 2.16 mm. Each braiding layer may have a thickness in the range of from 0.1 to 1.5 mm, preferably 0.2 to 1.0 mm, more preferably 0.3 to 0.6 mm, most preferably 0.4 mm. The copper tape may have a thickness in the range of from 0.05 to 1.2 mm, preferably 0.1 to 0.8 mm, more preferably 0.15 to 0.4 mm, most preferably 0.2 mm. The bedding/barrier layer may have a thickness in the range of from 0.2 to 2 mm, preferably 0.5 to 1.6 mm, more preferably 0.8 to 1.3 mm, most preferably 1.0 mm. The layer formed of the first plurality of wires may have a thickness in the range of from 1 to 4 mm, preferably 1.5 to 3 mm, more preferably 2 to 2.8 mm, most preferably 2.4 mm. The layer formed of the second plurality of wires may have a thickness in the range of from 1 to 3 mm, preferably 1.3 to 2.5 mm, more preferably 1.6 to 2 mm, most preferably 1.8 mm.

In another aspect, the present invention provides a use of a fluoropolymer as an insulator in a cable. In an embodiment, the cable is subjected to temperatures greater than 80° C., 90° C., 100° C., 110° C., 120° C., 130° C., 140° C., or 150° C.

The fluoropolymer may comprise, or consist of, a first monomer. The first monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene. Alternatively, the fluoropolymer may further comprise a second monomer, or the fluoropolymer may consist of a first and second monomer. The second monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. Particularly preferred fluoropolymers for use as an insulator are PTFE or ETFE.

In another aspect, the present invention provides a method of manufacturing a cable comprising three or more cores, each core comprising a conductor and an insulator layer disposed axially external to the conductor, wherein each core extends along a longitudinal axis of the cable, wherein the insulator layer comprises a first fluoropolymer, and a first plurality of wires disposed axially external to the three or more cores and extending along the longitudinal axis of the cable, comprising disposing the insulator layer around the conductor and along a longitudinal axis thereof to form each of the three or more cores, and disposing the first plurality of wires around the three or more cores and along the longitudinal axis of the cable.

The conductors may comprise tinned copper or copper alloy. The conductors may comprise a plurality of stranded wires. The plurality of the stranded wires of the conductors may be braided.

Braiding layers may also be provided, which may be disposed around the insulator layers. The filler may also be provided, which may be disposed in the interstices. A copper tape may also be provided, which may be disposed around the core bundle. A bedding/barrier layer may also be provided, which may be disposed around the copper tape.

The method further comprises the steps of providing a first plurality of wires, and disposing the first plurality of wires along the longitudinal axis of the cable and axially external to the bedding/barrier layer. The external surface of the bedding/barrier layer is preferably surrounded by the first plurality of wires. A second plurality of wires may be provided, which may then be disposed extending along the longitudinal axis of the cable and axially external to the first plurality of wires. The first plurality of wires may be helically wound in a first direction, and the wires of the second plurality of wires may be helically wound in a direction opposition to the first.

In another aspect the present invention provides a method of transmitting electricity, comprising providing a first installation or device and a second installation or device connected by a cable according to the present invention, and transmitting electricity from the first installation or device to the second installation or device through the cable, wherein the first installation or device is in a wellbore.

The first installation or device may be a sensor or an electrical submersible pump, or any other device typically used downhole for oil exploration or production that also requires electricity. The second installation or device may be a reel or spool, which may be installed at the surface.

The first device may be lowered into the wellbore by lowering a tension applied to the cable, i.e. by relaxing tension on the cable, the device or installation may lower into the wellbore under the influence of gravity. After the first device or installation has fulfilled its role or function downhole, it may be raised from the wellbore by increasing a tension to the cable. In other words, by pulling on the cable from the surface, the device or installation and the cable may be pulled out of the hole. The reel or spool installed on the surface may be used to lift or lower the device/installation from the surface, as well as storing any excess cable. Alternatively, a separate device, such as a hoist or winch may be used to lift/lower the first installation or device, and in this case, the reel or spool may be used to only store the excess cable.

### Example

The invention may be better understood with reference to the following example.

A cable was formed with the following characteristics:
Conductor: compact 37 wire, copper (33.6 mm²)
Insulator layer: PTFE (2.16 mm)
Braiding layer: aramid fibre (0.4 mm)
Filler: ETFE
Copper tape: copper alloy (0.2 mm)
Bedding/barrier layer: PTFE (1.0 mm)
Layer of first plurality of armour wire: nickel-based alloy (2.4 mm)
Layer of second plurality of armour wire: nickel-based alloy (1.8 mm)

This provides a cable having the following properties:
Outer diameter of 35.2 mm
Voltage rating 5 kV AC
Current rating 9 A
Weight 3.81 kg/m
Working load 149.2 kN
Minimum breaking tension 351 kN
Minimum bending radii (zero tension) 0.26 m; (92.1 kN operating tension) 0.39 m

### ADDITIONAL EMBODIMENTS

In addition to the claimed embodiments in the appended claims, the following is a list of additional embodiments which may serve as the basis for additional embodiments in this application or in subsequent divisional applications:

Embodiment 1—A cable comprising: three or more cores, each core comprising a conductor and an insulator layer disposed axially external to the conductor, wherein each core extends along a longitudinal axis of the cable, and wherein the insulator layer comprises a first fluoropolymer, and a first plurality of wires disposed axially external to the three or more cores and extending along a longitudinal axis of the cable.
Embodiment 2—A cable according to embodiment 1, wherein the three or more cores extend helically along the longitudinal axis of the cable.
Embodiment 3—A cable according to embodiment 1 or 2 comprising 4, 5, 6, 7, 8 or more cores.
Embodiment 4—A cable according to any preceding embodiment wherein the helices of each core intertwine.
Embodiment 5—A cable according to embodiment any preceding embodiment, wherein the fluoropolymer is a copolymer comprising a first monomer and a second monomer.
Embodiment 6—A cable according to embodiment 5, wherein the first monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.
Embodiment 7—A cable according to embodiment 5, wherein the first monomer is 1,1,2,2-tetrafluoroethylene.
Embodiment 8—A cable according to embodiment 5, wherein the first monomer is 1-fluoroethylene.
Embodiment 9—A cable according to embodiment 5, wherein the first monomer is 1,1-difluoroethylene.
Embodiment 10—A cable according to embodiment 5, wherein the first monomer is 1,2-difluoroethylene.
Embodiment 11—A cable according to embodiment 5, wherein the first monomer is 1,1,2-trifluoroethylene.
Embodiment 12—A cable according to embodiment 5, wherein the first monomer is hexafluoropropene.
Embodiment 13—A cable according to embodiment 5, wherein the first monomer is perfluoropropyl vinyl ether.
Embodiment 14—A cable according to embodiment 5, wherein the first monomer is perfluoroethyl vinyl ether.
Embodiment 15—A cable according to embodiment 5, wherein the first monomer is perfluoromethyl vinyl ether.
Embodiment 16—A cable according to embodiment 5, wherein the first monomer is perfluorobutyl ether.
Embodiment 17—A cable according to embodiment 5, wherein the first monomer is 1-chloro-1,2,2-trifluoroethylene.
Embodiment 18—A cable according to embodiment 5, wherein the first monomer is 1,1 dichloro 2,2, difluoroethylene.
Embodiment 19—A cable according to embodiment 5, wherein the first monomer is 1,2 dichloro 1,2, difluoroethylene.
Embodiment 20—A cable according to embodiment 5, wherein the first monomer is 1,1,2-trichloro-2-fluoro ethylene.
Embodiment 21—A cable according to embodiment 5, wherein the first monomer is hexafluoropropylene.
Embodiment 22—A cable according to any one of embodiments 5 to 21, wherein the second monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.
Embodiment 23—A cable according to any one of embodiments 5 to 22, wherein the second monomer is ethylene.
Embodiment 24—A cable according to any one of embodiments 5 to 22, wherein the second monomer is propylene.
Embodiment 25—A cable according to any one of embodiments 5 to 22, wherein the second monomer is 1,1,2,2-tetrafluoroethylene.
Embodiment 26—A cable according to any one of embodiments 5 to 22, wherein the second monomer is 1-fluoroethylene.
Embodiment 27—A cable according to any one of embodiments 5 to 22, wherein the second monomer is 1,1-difluoroethylene.
Embodiment 28—A cable according to any one of embodiments 5 to 22, wherein the second monomer is 1,2-difluoroethylene.
Embodiment 29—A cable according to any one of embodiments 5 to 22, wherein the second monomer is 1,1,2-trifluoroethylene.
Embodiment 30—A cable according to any one of embodiments 5 to 22, wherein the second monomer is hexafluoropropylene.
Embodiment 31—A cable according to any one of embodiments 5 to 22, wherein the second monomer is perfluoropropyl vinyl ether.
Embodiment 32—A cable according to any one of embodiments 5 to 22, wherein the second monomer is perfluoroethyl vinyl ether.
Embodiment 33—A cable according to any one of embodiments 5 to 22, wherein the second monomer is perfluoromethyl vinyl ether.
Embodiment 34—A cable according to any one of embodiments 5 to 22, wherein the second monomer is perfluorobutyl ether.
Embodiment 35—A cable according to any one of embodiments 5 to 22, wherein the second monomer is 1-chloro-1,2,2-trifluoroethylene.
Embodiment 36—A cable according to any one of embodiments 5 to 22, wherein the second monomer is 1,1 dichloro 2,2, difluoroethylene.
Embodiment 37—A cable according to any one of embodiments 5 to 22, wherein the second monomer is 1,2 dichloro 1,2, difluoroethylene.
Embodiment 38—A cable according to any one of embodiments 5 to 22, wherein the second monomer is 1,1,2-trichloro-2-fluoroethylene.
Embodiment 39—A cable according to any one of embodiments 5 to 22, wherein the second monomer is hexafluoropropylene.
Embodiment 40—A cable according to any one of embodiments 1 to 5, wherein the first fluoropolymer is polytetrafluoroethylene.
Embodiment 41—A cable according to any one of embodiments 1 to 5, wherein the first fluoropolymer is poly(ethylene-co-tetrafluoroethylene).
Embodiment 42—A cable according to any preceding embodiment wherein each core further comprises a braiding layer external to the insulator layer.
Embodiment 43—A cable according to embodiment 42 wherein the braiding layer comprises aramid fibre.
Embodiment 44—A cable according to embodiment 42 or 43, wherein interstices formed between the three or more cores comprise a filler material comprising a second fluoropolymer.
Embodiment 45—A cable according to embodiment 44, wherein the second fluoropolymer is a copolymer comprising a third monomer and a fourth monomer.
Embodiment 46—A cable according to embodiment 45, wherein the third monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.
Embodiment 47—A cable according to embodiment 45, wherein the third monomer is 1,1,2,2-tetrafluoroethylene.
Embodiment 48—A cable according to embodiment 45, wherein the third monomer is 1-fluoroethylene.
Embodiment 49—A cable according to embodiment 45, wherein the third monomer is 1,1-difluoroethylene.
Embodiment 50—A cable according to embodiment 45, wherein the third monomer is 1,2-difluoroethylene.
Embodiment 51—A cable according to embodiment 45, wherein the third monomer is 1,1,2-trifluoroethylene.
Embodiment 52—A cable according to embodiment 45, wherein the third monomer is hexafluoropropene.
Embodiment 53—A cable according to embodiment 45, wherein the third monomer is perfluoropropyl vinyl ether.
Embodiment 54—A cable according to embodiment 45, wherein the third monomer is perfluoroethyl vinyl ether.
Embodiment 55—A cable according to embodiment 45, wherein the third monomer is perfluoromethyl vinyl ether.
Embodiment 56—A cable according to embodiment 45, wherein the third monomer is perfluorobutyl ether.
Embodiment 57—A cable according to embodiment 45, wherein the third monomer is 1-chloro-1,2,2-trifluoroethylene.
Embodiment 58—A cable according to embodiment 45, wherein the third monomer is 1,1 dichloro 2,2, difluoroethylene.
Embodiment 59—A cable according to embodiment 45, wherein the third monomer is 1,2 dichloro 1,2, difluoroethylene.
Embodiment 60—A cable according to embodiment 45, wherein the third monomer is 1,1,2-trichloro-2-fluoro ethylene.
Embodiment 61—A cable according to embodiment 45, wherein the third monomer is hexafluoropropylene.
Embodiment 62—A cable according to any one of embodiments 45 to 61, wherein the fourth monomer is selected from a group consisting of ethylene, propylene, 1,1,2,2-tetrafluoroethylene, 1-fluoroethylene, 1,1-difluoroethylene, 1,2-difluoroethyl ene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.
Embodiment 63—A cable according to any one of embodiments 45 to 61, wherein the fourth monomer is ethylene.
Embodiment 64—A cable according to any one of embodiments 45 to 61, wherein the fourth monomer is propylene.
Embodiment 65—A cable according to any one of embodiments 45 to 61, wherein the fourth monomer is 1,1,2,2-tetrafluoroethylene.
Embodiment 66—A cable according to any one of embodiments 45 to 61, wherein the fourth monomer is 1-fluoroethylene.
Embodiment 67—A cable according to any one of embodiments 45 to 61, wherein the fourth monomer is 1,1-difluoroethylene.
Embodiment 68—A cable according to any one of embodiments 45 to 61, wherein the fourth monomer is 1,2-difluoroethylene.
Embodiment 69—A cable according to any one of embodiments 45 to 61, wherein the fourth monomer is 1,1,2-trifluoroethylene.
Embodiment 70—A cable according to any one of embodiments 45 to 61, wherein the fourth monomer is hexafluoropropylene.
Embodiment 71—A cable according to any one of embodiments 45 to 61, wherein the fourth monomer is perfluoropropyl vinyl ether.
Embodiment 72—A cable according to any one of embodiments 45 to 61, wherein the fourth monomer is perfluoroethyl vinyl ether.
Embodiment 73—A cable according to any one of embodiments 45 to 61, wherein the fourth monomer is perfluoromethyl vinyl ether.
Embodiment 74—A cable according to any one of embodiments 45 to 61, wherein the fourth monomer is perfluorobutyl ether.
Embodiment 75—A cable according to any one of embodiments 45 to 61, wherein the fourth monomer is 1-chloro-1,2,2-trifluoroethylene.
Embodiment 76—A cable according to any one of embodiments 45 to 61, wherein the fourth monomer is 1,1 dichloro 2,2, difluoroethylene.
Embodiment 77—A cable according to any one of embodiments 45 to 61, wherein the fourth monomer is 1,2 dichloro 1,2, difluoroethylene.
Embodiment 78—A cable according to any one of embodiments 45 to 61, wherein the fourth monomer is 1,1,2-trichloro-2-fluoroethylene.
Embodiment 79—A cable according to any one of embodiments 45 to 61, wherein the fourth monomer is hexafluoropropylene.
Embodiment 80—A cable according to embodiment 44 or 45, wherein the second fluoropolymer is polytetrafluoroethylene.
Embodiment 81—A cable according to embodiment 44 or 45, wherein the second fluoropolymer is poly(ethylene-co-tetrafluoroethylene).
Embodiment 82—A cable according to any preceding embodiment, further comprising a copper tape disposed axially external to the three or more cores.
Embodiment 83—A cable according to embodiments 82, further comprising a bedding/barrier layer comprising a third fluoropolymer, wherein the bedding/barrier layer extends along the longitudinal axis of the cable and is axially external to the copper tape.
Embodiment 84—A cable according to embodiment 83, wherein the third fluoropolymer is a copolymer comprising a fifth monomer and a sixth monomer.
Embodiment 85—A cable according to embodiment 84, wherein the fifth monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene. 86—A cable according to embodiment 84, wherein the fifth monomer is 1,1,2,2-tetrafluoroethylene.
Embodiment 87—A cable according to embodiment 84, wherein the fifth monomer is 1-fluoroethylene.
Embodiment 88—A cable according to embodiment 84, wherein the fifth monomer is 1,1-difluoroethylene.
Embodiment 89—A cable according to embodiment 84, wherein the fifth monomer is 1,2-difluoroethylene.
Embodiment 90—A cable according to embodiment 84, wherein the fifth monomer is 1,1,2-trifluoroethylene.
Embodiment 91—A cable according to embodiment 84, wherein the fifth monomer is hexafluoropropene.
Embodiment 92—A cable according to embodiment 84, wherein the fifth monomer is perfluoropropyl vinyl ether.
Embodiment 93—A cable according to embodiment 84, wherein the fifth monomer is perfluoroethyl vinyl ether.
Embodiment 94—A cable according to embodiment 84, wherein the fifth monomer is perfluoromethyl vinyl ether.
Embodiment 95—A cable according to embodiment 84, wherein the fifth monomer is perfluorobutyl ether.
Embodiment 96—A cable according to embodiment 84, wherein the fifth monomer is 1-chloro-1,2,2-trifluoroethylene.
Embodiment 97—A cable according to embodiment 84, wherein the fifth monomer is 1,1 dichloro 2,2, difluoroethylene.
Embodiment 98—A cable according to embodiment 84, wherein the fifth monomer is 1,2 dichloro 1,2, difluoroethylene.
Embodiment 99—A cable according to embodiment 84, wherein the fifth monomer is 1,1,2-trichloro-2-fluoro ethylene.
Embodiment 100—A cable according to embodiment 84, wherein the fifth monomer is hexafluoropropylene.
Embodiment 101—A cable according to any one of embodiments 84 to 100, wherein the sixth monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.
Embodiment 102—A cable according to any one of embodiments 84 to 100, wherein the sixth monomer is ethylene.
Embodiment 103—A cable according to any one of embodiments 84 to 100, wherein the sixth monomer is propylene.
Embodiment 104—A cable according to any one of embodiments 84 to 100, wherein the sixth monomer is 1,1,2,2-tetrafluoroethylene.
Embodiment 105—A cable according to any one of embodiments 84 to 100, wherein the sixth monomer is 1-fluoroethylene.
Embodiment 106—A cable according to any one of embodiments 84 to 100, wherein the sixth monomer is 1,1-difluoroethylene.
Embodiment 107—A cable according to any one of embodiments 84 to 100, wherein the sixth monomer is 1,2-difluoroethylene.
Embodiment 108—A cable according to any one of embodiments 84 to 100, wherein the sixth monomer is 1,1,2-trifluoroethylene.
Embodiment 109—A cable according to any one of embodiments 84 to 100, wherein the sixth monomer is hexafluoropropylene.
Embodiment 110—A cable according to any one of embodiments 84 to 100, wherein the sixth monomer is perfluoropropyl vinyl ether.
Embodiment 111—A cable according to any one of embodiments 84 to 100, wherein the sixth monomer is perfluoroethyl vinyl ether.
Embodiment 112—A cable according to any one of embodiments 84 to 100, wherein the sixth monomer is perfluoromethyl vinyl ether.
Embodiment 113—A cable according to any one of embodiments 84 to 100, wherein the sixth monomer is perfluorobutyl ether.
Embodiment 114—A cable according to any one of embodiments 84 to 100, wherein the sixth monomer is 1-chloro-1,2,2-trifluoroethylene.
Embodiment 115—A cable according to any one of embodiments 84 to 100, wherein the sixth monomer is 1,1 dichloro 2,2, difluoroethylene.
Embodiment 116—A cable according to any one of embodiments 84 to 100, wherein the sixth monomer is 1,2 dichloro 1,2, difluoroethylene.
Embodiment 117—A cable according to any one of embodiments 84 to 100, wherein the sixth monomer is 1,1,2-trichloro-2-fluoroethylene.
Embodiment 118—A cable according to any one of embodiments 84 to 100, wherein the sixth monomer is hexafluoropropylene.
Embodiment 119—A cable according to embodiment 83 or 84, wherein the third fluoropolymer is polytetrafluoroethylene.
Embodiment 120—A cable according to embodiment 83 or 84, wherein the third fluoropolymer is poly(ethylene-co-tetrafluoroethylene).
Embodiment 121—A cable according to any one of embodiments 83 to 120, wherein the first plurality is axially external to the three or more cores, and, if present, copper tape and the bedding/barrier layer.
Embodiment 122—A cable according to embodiment 121, further comprising a second plurality of wires, wherein the second plurality of wires extends along the longitudinal axis of the cable and is axially external to the first plurality of wires.
Embodiment 123—A cable according to embodiment 122 wherein the wires of the first plurality of wires are helically wound in a first direction, and the wires of the second plurality of wires are helically wound in a direction opposite to the first direction.
Embodiment 124—A cable according to any preceding embodiment, wherein the conductors comprise copper or copper alloy.
Embodiment 125—A cable according to any preceding embodiment, wherein the conductors comprise a plurality of stranded wires.
Embodiment 126—A cable according to embodiment 125, wherein the plurality of the stranded wires of the conductors are braided.
Embodiment 127—A cable according to any of embodiments 121 to 126, wherein the first plurality of wires and/or the second plurality of wires comprises an alloy comprising nickel.
Embodiment 128—A cable according to any of embodiments 121 to 126, wherein the first plurality of wires and/or the second plurality of wires comprises an alloy consists of nickel, chromium and optionally up to 20% (w/w) additives or impurities.
Embodiment 129—A cable according to embodiment 128 wherein the alloy consists of from 40 to 74% (w/w) nickel, 14 to 25% (w/w) chromium, and optionally up to 20% (w/w) additives or impurities.
Embodiment 130—A cable according to embodiment 128 or 129 wherein the additives or impurities are selected from iron, molybdenum, niobium, cobalt, manganese, copper, aluminium, titanium, silicon, carbon, sulphur, phosphorus or boron, or any combination thereof,
Embodiment 131—A cable according to any of embodiments 127 to 130 wherein the alloy consists of 58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives.
Embodiment 132—A use of a fluoropolymer as an insulator in an armoured cable.
Embodiment 133—A use according to embodiment 132, wherein the cable is used downhole.
Embodiment 134—A use according to embodiment 132 or 133, wherein the cable is subjected to temperatures greater than 100° C., preferably 110° C., more preferably 120° C.
Embodiment 135—A use according to embodiment 132, 133 or 134, wherein the fluoropolymer is a copolymer comprising a first monomer and a second monomer.
Embodiment 136—A use according to embodiment 135, wherein the first monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2h, difluoroethylene, 1,2 dichloro 1,2, difluoroethylene, 1,1,2-trichloro-2-fluoroethylene, and hexafluoropropylene.
Embodiment 137—A use according to embodiment 135, wherein the first monomer is 1,1,2,2-tetrafluoroethylene.
Embodiment 138—A use according to embodiment 135, wherein the first monomer is 1-fluoroethylene.
Embodiment 139—A use according to embodiment 135, wherein the first monomer is 1,1-difluoroethylene.
Embodiment 140—A use according to embodiment 135, wherein the first monomer is 1,2-difluoroethylene.
Embodiment 141—A use according to embodiment 135, wherein the first monomer is 1,1,2-trifluoroethylene.
Embodiment 142—A use according to embodiment 135, wherein the first monomer is hexafluoropropene.
Embodiment 143—A use according to embodiment 135, wherein the first monomer is perfluoropropyl vinyl ether.
Embodiment 144—A use according to embodiment 135, wherein the first monomer is perfluoroethyl vinyl ether.
Embodiment 145—A use according to embodiment 135, wherein the first monomer is perfluoromethyl vinyl ether.
Embodiment 146—A use according to embodiment 135, wherein the first monomer is perfluorobutyl ether.
Embodiment 147—A use according to embodiment 135, wherein the first monomer is 1-chloro-1,2,2-trifluoroethylene.
Embodiment 148—A use according to embodiment 135, wherein the first monomer is 1,1 dichloro 2,2, difluoroethylene.
Embodiment 149—A use according to embodiment 135, wherein the first monomer is 1,2 dichloro 1,2, difluoroethylene.
Embodiment 150—A use according to embodiment 135, wherein the first monomer is 1,1,2-trichloro-2-fluoro ethylene.
Embodiment 151—A use according to embodiment 135, wherein the first monomer is hexafluoropropylene.
Embodiment 152—A use according to any one of embodiments 135 to 151, wherein the second monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.
Embodiment 153—A use according to any one of embodiments 135 to 151, wherein the second monomer is ethylene.
Embodiment 154—A use according to any one of embodiments 135 to 151, wherein the second monomer is propylene.
Embodiment 155—A use according to any one of embodiments 135 to 151, wherein the second monomer is 1,1,2,2-tetrafluoroethylene.
Embodiment 156—A use according to any one of embodiments 135 to 151, wherein the second monomer is 1-fluoroethylene.
Embodiment 157—A use according to any one of embodiments 135 to 151, wherein the second monomer is 1,1-difluoroethylene.
Embodiment 158—A use according to any one of embodiments 135 to 151, wherein the second monomer is 1,2-difluoroethylene.
Embodiment 159—A use according to any one of embodiments 135 to 151, wherein the second monomer is 1,1,2-trifluoroethylene.
Embodiment 160—A use according to any one of embodiments 135 to 151, wherein the second monomer is hexafluoropropylene.
Embodiment 161—A use according to any one of embodiments 135 to 151, wherein the second monomer is perfluoropropyl vinyl ether.
Embodiment 162—A use according to any one of embodiments 135 to 151, wherein the second monomer is perfluoroethyl vinyl ether.
Embodiment 163—A use according to any one of embodiments 135 to 151, wherein the second monomer is perfluoromethyl vinyl ether.
Embodiment 164—A use according to any one of embodiments 135 to 151, wherein the second monomer is perfluorobutyl ether.
Embodiment 165—A use according to any one of embodiments 135 to 151, wherein the second monomer is 1-chloro-1,2,2-trifluoroethylene.
Embodiment 166—A use according to any one of embodiments 135 to 151, wherein the second monomer is 1,1 dichloro 2,2, difluoroethylene.
Embodiment 167—A use according to any one of embodiments 135 to 151, wherein the second monomer is 1,2 dichloro 1,2, difluoroethylene.
Embodiment 168—A use according to any one of embodiments 135 to 151, wherein the second monomer is 1,1,2-trichloro-2-fluoroethylene.
Embodiment 169—A use according to any one of embodiments 135 to 151, wherein the second monomer is hexafluoropropylene.
Embodiment 170—A use according to any one of embodiments 132 to 135, wherein the fluoropolymer is polytetrafluoroethylene.
Embodiment 171—A use according to any one of embodiments 132 to 135, wherein the fluoropolymer is poly(ethylene-co-tetrafluoroethylene).
Embodiment 172—A method of manufacturing a cable according to any one of embodiments 1 to 131, comprising disposing the insulator layer around the conductor and along a longitudinal axis thereof to form each of the three or more cores, and disposing the first plurality of wires around the three or more cores and along the longitudinal axis of the cable.
Embodiment 173—A method according to embodiment 172, comprising providing a braiding layer, and disposing the braiding layer around the insulating layer of each core.
Embodiment 174—A method according to embodiment 173, comprising providing filler material, and disposing the filler material in the interstices formed between the three or more cores.
Embodiment 175—A method according to embodiment 174, comprising providing a copper tape, and disposing the copper tape around the three or more cores.
Embodiment 176—A method according to embodiment 175, comprising providing a bedding/barrier layer, and disposing the bedding/barrier layer around the copper tape.
Embodiment 177—A method of transmitting electricity, comprising providing a first installation or device and a second installation or device connected by a cable according to any one of embodiments 1 to 131, and transmitting electricity from the first installation or device to the second installation or device through the cable, wherein the first installation or device is in a wellbore.
Embodiment 178—A method according to embodiment 177, wherein the first installation or device is a sensor.
Embodiment 179—A method according to embodiment 177, wherein the first installation or device is an electrical submersible pump.
Embodiment 180—A method according to any of embodiments 177 to 179, wherein the second installation or device is a winch, reel or spool.
Embodiment 181—A method according to any of embodiments 177 to 180, wherein the first device or installation is lowered into the wellbore by lowering a tension applied to the cable.
Embodiment 182—A method according to any of embodiments 177 to 181, wherein the first device or installation is raised from the wellbore by increasing a tension to the cable.
Embodiment 183—A method of suspending a first device or installation in a wellbore, comprising providing a cable according to any one of embodiments 1 to 131, securing a first end of the cable to the first device or installation, securing a second end of the cable to a second device or installation, and suspending the first device or installation in the wellbore.
Embodiment 184—A method according to embodiment 183 wherein the first installation or device is a sensor.
Embodiment 185—A method according to embodiment 184 wherein the first installation or device is an electrical submersible pump.
Embodiment 186—A method according to any of embodiments 183 to 185, wherein the second installation or device is a winch, reel or spool.
Embodiment 187—A method according to any of embodiments 183 to 186 wherein the second installation or device is located at the surface.
Embodiment 188—A method according to any of embodiments 183 to 187, wherein the first device or installation is lowered into the wellbore by lowering a tension applied to the cable.
Embodiment 189—A method according to any of embodiments 183 to 187, wherein the first device or installation is raised from the wellbore by increasing a tension to the cable.
Embodiment 190—A method according to any of embodiment 183 to 189, further comprising transmitting electricity from the first installation or device to the second installation or device through the cable.
Embodiment 191—A cable substantially as herein described, with reference to the drawings.
Embodiment 192—A method of manufacturing a cable substantially as herein described, with reference to the drawings.

1. A cable comprising:
three or more cores, each core comprising a conductor and an insulator layer disposed axially external to the conductor, wherein each core extends along a longitudinal axis of the cable, wherein the insulator layer comprises a first fluoropolymer, and
a first plurality of wires disposed axially external to the three or more cores and extending along the longitudinal axis of the cable.

2. The cable of claim 1, wherein the three or more cores extend helically along the longitudinal axis of the cable, wherein the helices of each core preferably intertwine.

3. The cable of claim 1, wherein the fluoropolymer is a copolymer comprising:
a first monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
a second monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
preferably wherein the first fluoropolymer is polytetrafluoroethylene or poly(ethylene-co-tetrafluoro ethylene).

4. The cable of claim 1 wherein each core further comprises a braiding layer external to the insulator layer and extending along the longitudinal axis of the cable, wherein the braiding layer preferably comprises aramid fibre.

5. The cable of claim 1, wherein interstices formed between the three or more cores comprise a filler material comprising a second fluoropolymer.

6. The cable of claim 5, wherein the second fluoropolymer is a copolymer comprising:
a third monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
a fourth monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
wherein the second fluoropolymer preferably is polytetrafluoroethylene or poly(ethylene-co-tetrafluoroethylene).

7. The cable of claim 1, further comprising a copper tape disposed axially external to the three or more cores and extending along the longitudinal axis of the cable.

8. The cable of claim 7, further comprising a bedding/barrier layer comprising a third fluoropolymer, wherein the bedding/barrier layer extends along the longitudinal axis of the cable and is axially external to the copper tape.

9. The cable of claim 8, wherein the third fluoropolymer is a copolymer comprising:
a fifth monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
a sixth monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
wherein the third fluoropolymer preferably is polytetrafluoroethylene or poly(ethylene-co-tetrafluoroethylene).

10. The cable of claim 1, further comprising a second plurality of wires, wherein the second plurality of wires extends along the longitudinal axis of the cable and is axially external to the first plurality of wires.

11. The cable of claim 10 wherein the wires of the first plurality of wires are helically wound in a first direction, and the wires of the second plurality of wires are helically wound in a direction opposite to the first direction.

12. The cable of claim 1, wherein the conductors comprise copper or copper alloy.

13. The cable of claim 1, wherein the conductors comprise a plurality of stranded wires, preferably wherein the plurality of the stranded wires are braided.

14. The cable of claim 1, wherein the first plurality of wires comprises an alloy comprising nickel.

15. The cable of claim 1, wherein the first plurality of wires comprises an alloy consisting of:
nickel, chromium and optionally up to 20% (w/w) additives or impurities;
40 to 74% (w/w) nickel, 14 to 25% (w/w) chromium, and optionally up to 20% (w/w) additives or impurities;
58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives;
72% (w/w) nickel, 14-17% (w/w) chromium, 6-10% (w/w) iron, 1% (w/w) manganese, 0.5% (w/w) copper, with remainder impurities or additives;
44.2%-56% (w/w) nickel, 20-24% (w/w) chromium, 3% (w/w) iron, 8-10% (w/w) molybdenum, 10-15% (w/w) cobalt, 0.5% (w/w) manganese, 0.5% (w/w) copper, 0.8-1.5% (w/w) aluminium, 0.6% (w/w) titanium with remainder impurities or additives;
50-55% (w/w) nickel, 17-21% (w/w) chromium, 2.8-3.3% (w/w) molybdenum, 4.75-5.5% (w/w) niobium, 1% cobalt, 0.35% (w/w) manganese, 0.2-0.8% (w/w) aluminium, 0.65-1.15% (w/w) titanium, 0.3% (w/w) copper with remainder impurities or additives; or
70% (w/w) nickel, 14-17% (w/w) chromium, 5-9% (w/w) iron, 0.7-1.2% (w/w) niobium, 1% (w/w) cobalt, 1% (w/w) manganese, 0.5% (w/w) copper, 0.4-1% (w/w) aluminium, 2.25-2.75% (w/w) titanium with remainder impurities or additives.

16. The cable of claim 15 wherein the additives or impurities are selected from iron, molybdenum, niobium, cobalt, manganese, copper, aluminium, titanium, silicon, carbon, sulphur, phosphorus or boron, or any combination thereof.

17. A method of manufacturing the cable of claim 1, comprising:
disposing the insulator layer around the conductor and along a longitudinal axis thereof to form each of the three or more cores, and disposing the first plurality of wires Oaround the three or more cores and along the longitudinal axis of the cable.

18. A method of transmitting electricity, comprising providing a first installation or device and a second installation or device connected by the cable of claim 1, and transmitting electricity from the first installation or device to the second installation or device through the cable, wherein the first installation or device is in a wellbore.

19. The method of claim 18, further comprising lowering the first device or installation into the wellbore by lowering a tension applied to the cable, and/or raising the first device or installation from the wellbore by increasing a tension to the cable.

20. A method of suspending a first device or installation in a wellbore, comprising providing the cable of claim 1, securing a first end of the cable to the first device or installation, securing a second end of the cable to a second device or installation, and suspending the first device or installation in the wellbore.

21. The method of claim 20 further comprising transmitting electricity from the first installation or device to the second installation or device through the cable.
